(19) United States
(12) Patent Application Publication
(10) Pub. No.: US 2011/0010563 A1
(43) Pub. Date: Jan. 13, 2011

(54) METHOD AND APPARATUS FOR ANONYMOUS DATA PROCESSING

(75) Inventors: Denny Lung Sun Lee, Ottawa (CA); Michael Gassewitz, Ottawa (CA); Rob Gaudet, Ottawa (CA); Kelvin Edmison, Ottawa (CA); Roderick William Macdonald, Ottawa (CA)

Correspondence Address: OSHA LIANG L.L.P., TWO HOUSTON CENTER, 909 FANNIN, SUITE 3500, HOUSTON, TX, 77010, US

(73) Assignee: KINDSIGHT, INC., Sunnyvale, CA (US)

(21) Appl. No.: 12/834,745

(22) Filed: Jul. 12, 2010

Related U.S. Application Data
(60) Provisional application No. 61/225,203, filed on Jul. 13, 2009.

(51) Int. Cl. G06F 12/14

(52) U.S. Cl. 713/189

(57) ABSTRACT

A system, a method and a computer readable medium for anonymizing collected data associated with one or more data owners is provided. An identifier is received and a hash process is performed using the identifier and a cryptographic salt to produce a hash output. The hash output is associated with an anonymous identifier. The anonymous identifier is then associated with the data. The anonymized data may then be provided to one or more third party processors for processing an analysis.

### CROSS-REFERENCE TO RELATED APPLICATIONS

This application claims priority under 35 U.S.C.§119(e) to U.S. Provisional Application Ser. No. 61/225,203, filed on Jul. 13, 2009, the content of which is hereby incorporated by reference in its entirety.

### BACKGROUND OF INVENTION

1. Field of the Invention

The present disclosure relates to the field of secured data processing and in particular to an apparatus and method for anonymizing data for further processing.

2. Background Art

Data owners, which can also include those that have generated the data or those who are associated with the generated data, are increasingly concerned with the privacy and the security of their data. Those that have earned or been given the right to electronically process this data, referred to herein as third party data processors, must ensure its security and integrity. Processing of the data may include the storage and/or analysis of the data as well as transformation of the data, for example using the original data as input to generate output data. One technique that can be used to enhance security is to process the data in an anonymous fashion. Anonymous data processing typically includes replacing an identifier of the data owner, such as a name or numerical identifier, included in or with the data with a proxy identifier such as a serially assigned unique number. This allows other unproxied information in the data, for example an income range, to be associated with independent data owners when being processed while also preventing the unproxied information from being easily attributed or tracked back to the actual data owner using the proxied data.

While the use of proxy identifiers is effective in anonymizing data during downstream processing, proxying the data directly limits the flexibility of an anonymizing system. For example, in the case where separate data items, such as postal code and gender, associated with the same data owner are provided to two or more downstream data processors using the same proxy identifier for the data owner, the possibility of correlating the postal code to the gender exists if the different data processors share or exchange data. When two or more data processors are able to correlate the anonymized data that they receive from the data processor, then the data owner's privacy and security has a higher potential to be at least partially compromised. For example, two data processors, one that receives postal code data and one that receives gender data, could collectively determine that a person (or number of persons) of a particular gender live in a particular postal code. As will be appreciated, the forgoing example is a trivial illustration; however with larger amounts of data extensive correlation analysis of anonymized data may result in discovery of multiple characterizing data items attributable to one or more data owners.

Furthermore, even if the data is provided to only one data processor, directly proxying data is inflexible since it may be difficult to change the proxied value associated with a particular data owner.

Therefore, there is a need for a mechanism for anonymous data processing that mitigates the possibility of compromising data owners' privacy and security when data associated with the data owner is provided to multiple downstream data processors and/or provides flexible anonymization of data.

### SUMMARY OF INVENTION

In accordance with the present disclosure there is provided a method, implemented in a processing unit of anonymizing data of one or more data owners. The method comprises receiving an identifier and data associated with a data owner of the one or more data owners, determining a static owner identifier using the received identifier, performing a first hashing process using a first generated cryptographic salt and the static owner identifier to generate a first unique one-way hash result (HASH1) associated with the static owner identifier, determining a first anonymous identifier (AID1) associated with the HASH1 and storing in a memory unit associated with the processing unit the determined AID1 with at least a first portion of data (DATA1) associated with the received data.

In accordance with the present disclosure there is further provided a system for anonymizing data associated with a subscriber, the device comprising a computer readable memory unit for storing instructions and data, a network interface coupling the device to a network, and a processing unit for executing the instructions stored in the computer readable memory unit, the instructions when executed by the processing unit configuring the system to perform a method, implemented in a processing unit of anonymizing data of one or more data owners. The method comprises receiving an identifier and data associated with a data owner of the one or more data owners, determining a static owner identifier using the received identifier, performing a first hashing process using a first generated cryptographic salt and the static owner identifier to generate a first unique one-way hash result (HASH1) associated with the static owner identifier, determining a first anonymous identifier (AID1) associated with the HASH1 and storing in a memory unit associated with the processing unit the determined AID1 with at least a first portion of data (DATA1) associated with the received data.

In accordance with the present disclosure there is further still provided a computer readable memory storing instructions for configuring a computer to perform a method, implemented in a processing unit of anonymizing data of one or more data owners. The method comprises receiving an identifier and data associated with a data owner of the one or more data owners, determining a static owner identifier using the received identifier, performing a first hashing process using a first generated cryptographic salt and the static owner identifier to generate a first unique one-way hash result (HASH1) associated with the static owner identifier, determining a first anonymous identifier (AID1) associated with the HASH1 and storing in a memory unit associated with the processing unit the determined AID1 with at least a first portion of data (DATA1) associated with the received data.

### BRIEF DESCRIPTION OF DRAWINGS

Embodiments are described herein with reference to the drawings in which:

FIG. 1 depicts in a block diagram an embodiment of a system for anonymizing data;

FIG. 2 depicts in a block diagram an environment in which an anonymizing system may be used;

FIG. 3 depicts in a block diagram an embodiment of an anonymizer that may be used to anonymize data;

FIG. 4 depicts in a block diagram a further embodiment of an anonymizer that may be used to anonymize data;

FIG. 5 depicts in a block diagram a further embodiment of an anonymizer that may be used to anonymize data;

FIG. 6 depicts in a flow chart an embodiment of a method of anonymizing data;

FIG. 7 depicts in a flow chart a further embodiment of a method of anonymizing data;

FIG. 8 depicts in a flow chart an embodiment of a method of tracking dynamic identifiers; and

FIG. 9 depicts in a flow chart an embodiment of a method of providing access to anonymized data.

### DETAILED DESCRIPTION

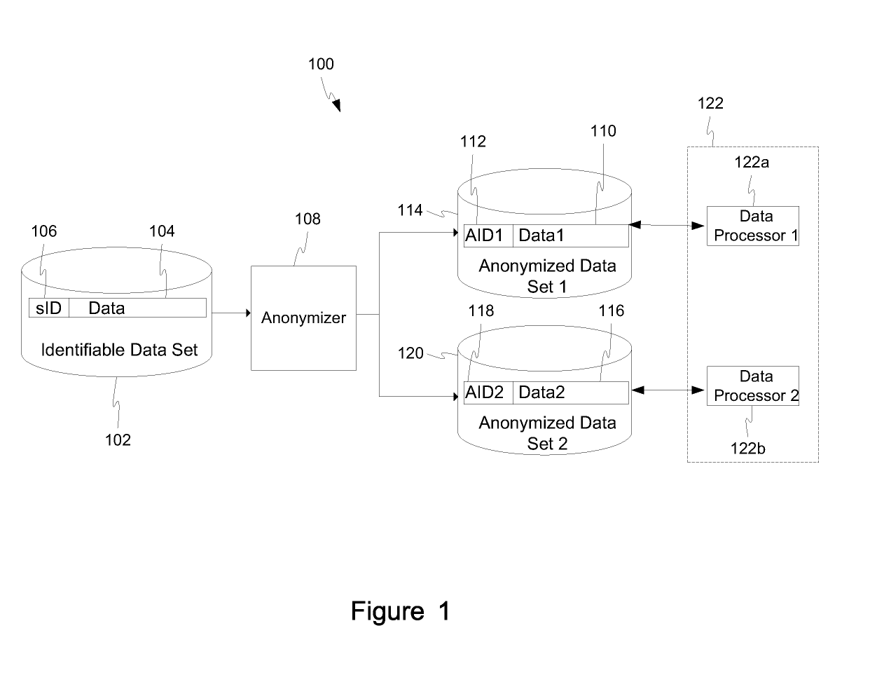

FIG. 1 depicts in a block diagram an embodiment of a system 100 for anonymizing data. A data repository 102 is used to store a various data 104 that is associated with a static owner identifier (sID) 106 associated with an owner of the data. By way of example, the repository 102 could be a database storing click-stream data associated with a subscriber of an Internet Service Provider (ISP). The data 104 may contain information such as a profile associated with the subscriber. It will be appreciated that the data 104 may be any type of data that is associated with a static owner identifier of the data owner. Furthermore, the data repository 102 may store multiple pieces of data associated with the same static owner identifier as well as data 102 associated with different static owner identifiers 106. The static owner identifier 106 may be various identifiers that can be used to uniquely identify the subscriber. For example the static owner identifier 106 may be a MAC address of a modem associated with the subscriber, a user name of the subscriber or other similar identifier. Additionally or alternatively, the data repository 102 may store an identifier that can be associated to a static owner identifier instead of the static owner identifier itself.

The data repository 102 may be any repository of data associated with a data owner. Additionally or alternatively, the data 104 and associated static owner identifier 106 may be received individually or in batches from one or more processes or components. The stored data may be data-of-interest that is to be provided to one or more downstream data processors 122. The data contained in the data repository 102 may include a plurality or set of information of various types and various formats and ranges. Each set of information may be associated with a data owner via a static owner identifier that uniquely identifies the data owner. In addition, as described further herein, the data owner may have one or more dynamic identifiers that uniquely identify the data owner, but that can change over time to identify a different data owner. The static owner identifier is persistent and does not change with time, whereas each dynamic identifier can change over time. In an example used herein, a data owner may be an Internet access subscribing household, the data-of-interest may include the Internet data traffic to and from the household, also referred to as click stream data. The data may also comprise data resulting from the processing of the click stream data. The traffic data to and from the household is associated with an Internet Protocol (IP) address that can change dynamically over time. This IP address may be the dynamic identifier. The data owner may be associated with one or more static owner identifiers such as, for example, an account identifier provided by an Internet Service Provider (ISP) and a media access control (MAC) address associated with a modem used to access the Internet through the ISP. It is possible for the ISP, or authority that provides the dynamic identifier, to determine the static owner identifier from the dynamic identifier. The dynamic identifier has been described above as a dynamically assigned IP address. It will be appreciated that IP addresses may also be statically assigned. It may also be possible to determine the static owner identifier, for example the MAC address, from a static identifier such as a statically assigned IP address, using the same process used for determining a static owner identifier from a dynamic identifier. Additionally or alternatively, the static identifier may be used as the static owner identifier.

It may be desirable to have the data 104 stored in the data repository 102 processed by a third party processor 122. However it may not be desirable to provide the data 104 associated with the static owner identifier 106 to the third party due to privacy or other concerns. In order to provide the data stored in the data repository to a third party without being able to associate the data to the data owner using the static owner identifier, the data is first anonymized. An anonymizer 108 receives the data 104 and associated static owner identifier 106. The anonymizer 108 associates an anonymous identifier (AID) with the data. In the example depicted in FIG. 1, the data 104 stored in the repository 102 includes two types of data. The anonymizer 108 associates a first type of data 110 with a first AID 112, which may then be stored in a repository 114. The data stored in the repository 114 is anonymized; however, data that was associated with the same static owner identifier in the identifiable repository 102 is associated with the same AID in the anonymized data set stored in the repository 114. The anonymizer 108 also associates a second type of data 116 with a second AID 118, which may then be stored in a repository 120.

The data stored in the repositories 114, 120 may be provided to different third party processors 122a, 122b (referred to collectively as third party processors 122). The third party processors 122a, 122b may process the data and store results in the repositories 114, 120 or alternatively in another repository. Since the anonymizer 108 associates different AIDs with different types of data, or with different copies of the same type of data, associated with the same static owner identifier, the third party processors 122a, 122b will not be able to associate the different data types back to the same data owner. Additional privacy may be provided by providing different AIDs based on the type of data, the third party processor the data is to be provided to, or both.

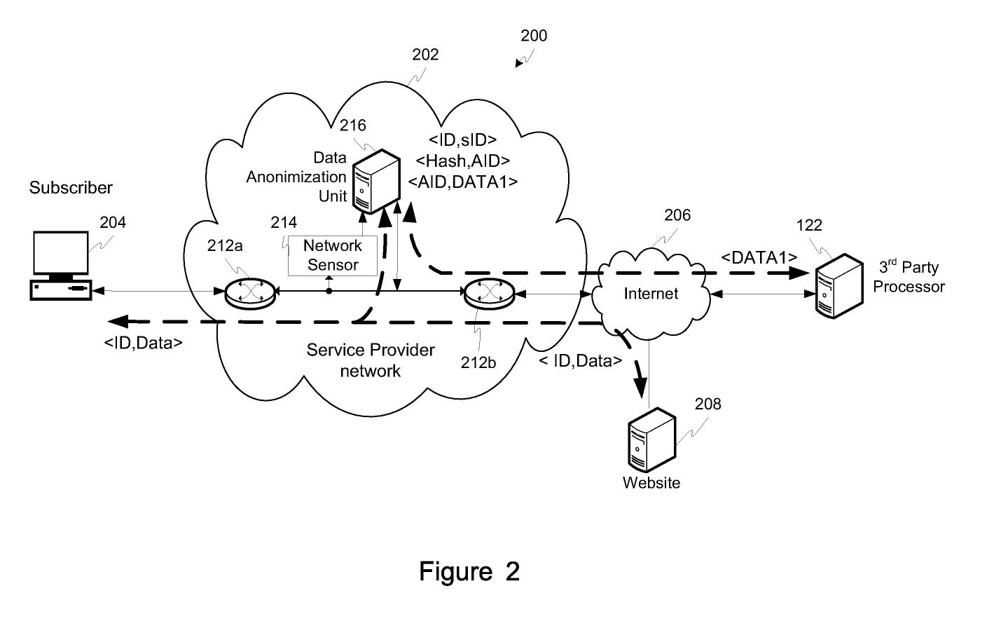

FIG. 2 depicts in a block diagram an environment 200 in which the anonymizing system 100 may be used. The environment 200 comprises an ISP network 202 that connects a subscriber's computer 204 to the Internet 206. The ISP network 202 may be used to send data between the subscriber's computer 204 and a website 208. The ISP network 202 may also communicate with one or more third party processors 122. The ISP network 202 may communicate data collected on its network 202 to the third party processors 122 for processing. Third party processors 122 are depicted as being coupled to the data processor 216 through the Internet. The third party processor may be connected in other ways, such as through a direct connection, a private network, or a virtual private network connection (VPN).

The ISP network 202 comprises a plurality of switches, routers or other network equipment 212a, 212b that routes data between the subscriber's computer 204 and the Internet 206. One or more network sensors 214 collect data from the ISP network. The data collected may be associated with a static owner identifier, or other identifier that can be used to determine an associated static owner identifier of the data owner. As will be appreciated, the static owner identifier may need to be determined from the network traffic. For example, if the subscriber's computer 204 is assigned an Internet Protocol (IP) address dynamically, the static owner identifier may be determined by using the dynamically assigned IP address to look up, or request from the address authority, the associated static owner identifier.

The network sensors 214 may pass the collected data to a data anonymization unit 216 that implements at least a portion of the anonymization system 100 including the anonymizer 108. The data anonymization unit 216 may comprise a processing unit and a memory unit (not depicted). As will be appreciated, the processing unit may comprise one or more processors coupled together. The one or more processors of the processing unit may be arranged on the same physical chip, or they may be arranged on multiple separate chips. Additionally, the processing unit may be further comprised of multiple processors or computing devices containing one or more processors coupled together, for example over a network. Similarly, the memory unit may comprise a plurality of memory devices for storing information. The memory devices of the memory unit may store information, including instructions and data, in volatile memory. The memory unit may also comprise memory devices for storing information in non-volatile storage. The data anonymization unit 216 is depicted as being a single physical component, as will be appreciated that data anonymization unit 216 may include multiple physical components coupled together. The multiple components may be located in the same location or may be located in different geographical locations.

Regardless of the specific physical configuration of the data anonymization unit 216, the data anonymization unit 216 is configured to anonymize the data collected by the one or more network sensors 214. The anonymized data may then be provided to one or more third party processors 122.

As depicted in FIG. 2 data passed from the subscriber's computer 204 to the ISP network 202 is associated with an identifier. The identifier may be a dynamic identifier or other identifier that is associated with the data owner, which in the embodiment of FIG. 2 is the subscriber. The ISP network 202 passes the data and associated identifier onto a website 208 or other communication service. The network sensor 214 passes the identifier and data onto the data anonymization unit 216. As described further below, the data anonymization unit 216 may associate the identifier with a static owner identifier (sID). A hash based on the static owner identifier is associated with an anonymous identifier (AID), which in turn is associated with the data or a portion of the data (DATA1). Additionally or alternatively, the data associated with the AID may be based on processed data collected by the ISP network over a period of time. The data anonymization unit 216 may pass the data (DATA1) to the third party processor 122. The data (DATA1) may be passed onto to the third party processor 122 with or without the associated AID (AID1). Passing the data (DATA1) to the third party processor 122 without the AID (AID1), as depicted in FIG. 2, may provide greater security for the anonymized data.

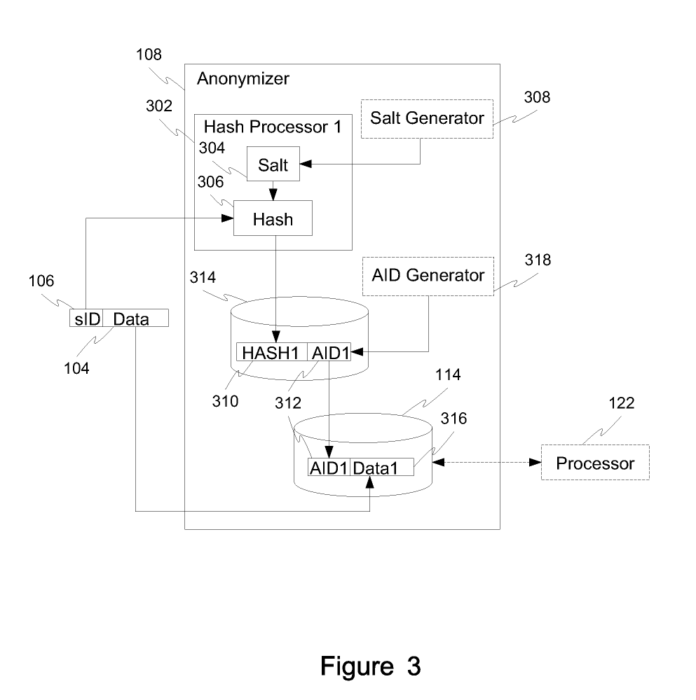

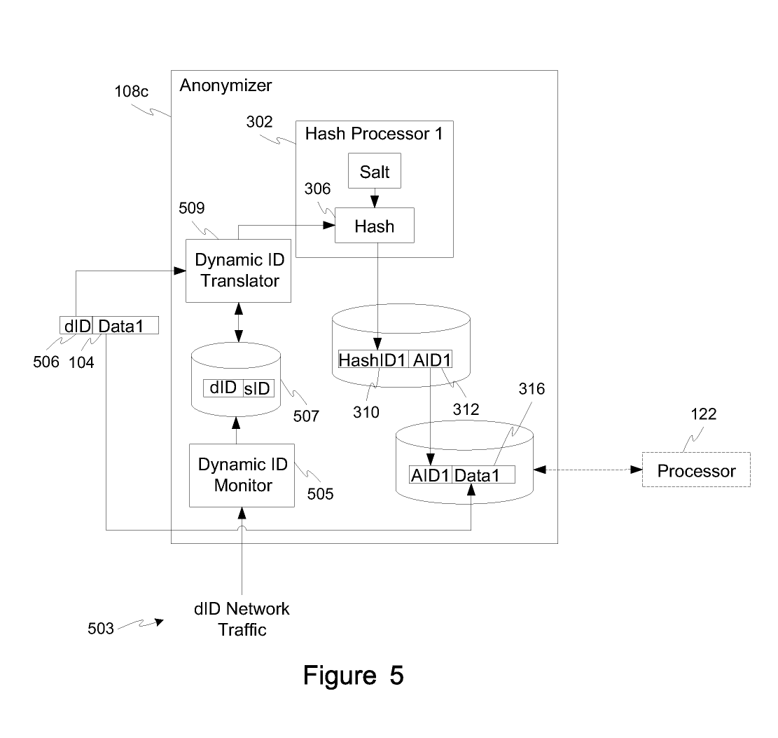

FIG. 3 depicts in a block diagram an embodiment of an anonymizer 108 that may be used to anonymize data. The anonymizer 108 may be used to anonymize data received in a real-time or near real-time stream, for example as a stream of data and associated identifiers received from the network sensor 214. Additionally or alternatively the data and associated identifiers may be received, or retrieved, from a data repository storing data to be anonymized. As depicted in FIG. 3, the anonymizer receives data 104 associated with a static owner identifier 106 of the data owner; however, as described further herein with reference to FIG. 5, the anonymizer 108 may receive an identifier and determine a static owner identifier 106 using the received identifier.

The anonymizer 108 receives a static owner identifier 106 that identifies the data owner and is associated with the data 104. The anonymizer 108 comprises a hash processor 302 that receives the static owner identifier 106. The hash processor 302 provides a one-way hash process that takes the static owner identifier 106 and a cryptographic salt 304 as input. The cryptographic salt 304 is a plurality of random bits that are used to help prevent the resultant hash from being reversed using a dictionary type attack. The hash process 306 takes the cryptographic salt 304 and the static owner identifier 106 as input and produces a fixed length string based on the inputs. Given the same inputs, the hash process will produce the same output. Given different inputs, the hash process 306 will, with a high probability, produce different outputs. Given the output of the hash process 306, it is mathematically complex to determine the original inputs, as such the hash process provides a one-way association between the input and output. Additionally, by using the cryptographic salt 304, it is more difficult to retrieve the static owner identifier from the output, since the salt value would need to be known in order to determine the static owner identifier 106. The hash process may be any appropriate one way function. For example the hash process may implement a message digest process such as Message-Digest algorithm 5 (MD5), or a secure hash algorithm such as Secure Hash Algorithm (SHA) 128 or SHA 256.

The cryptographic salt 304 used by the hash processor 302 is the same for all static owner identifiers that are hashed. The cryptographic salt 304 may be changed periodically; however; once the salt used is changed, inputting the same static owner identifier 106 into the hash processor 302 will produce a different output, and as such any data associated with the previous hash output of the static owner identifier 106 will be inaccessible, or will not be able to be associated with the same static owner identifier. If it is desirable to periodically change the salt used but still have the static owner identifier be associable to the previous hash output the old salt can be saved. Alternatively it may be desirable to periodically change the salt without storing it in order to make it impossible to associate data anonymized with the old salt with data anonymized with the new salt. For example, if the salt is changed once a month, only one month's worth of data will be able to be associated with a particular static owner identifier.

The cryptographic salt 304 may be provided in various ways. As depicted in FIG. 3, the salt may be provided from a salt generator 308. The salt generator 308 may create the salt in various ways. For example, the salt generator 308 may generate a random number that is used as the salt 304. The salt generator 308 may use other methods in order to produce the salt 304.

The salt 308 may be generated internally by the anonymizer 108 and the resultant salt inaccessible from processes external to the anonymizer 108. Additional privacy may be provided by having the salt 304 inaccessible from outside the anonymizer 108 since the salt 304 used when hashing a static owner identifier 106 must be known in order to be able to determine the static owner identifier 106 from the output of the hash process 306.

The salt generator 308 may produce the cryptographic salt 304, which is then stored in volatile memory of the memory unit. Alternatively, the cryptographic salt 304 may be produced by the salt generator 308 each time it is required by the hash process 306. The salt 304 stored in the volatile memory may be stored in a secured area of the volatile memory so that it is inaccessible to processes external to the anonymizer 108. The salt 304 stored in the protected memory of the memory unit may be accessed by the hash process 306 as required. Additionally or alternatively, the salt 304 may be stored in non-volatile memory of the memory unit. By storing the cryptographic salt 304 in non-volatile storage, the same salt may be used even following a power failure or rebooting of the anonymizer 108, or the hardware that has been configured to implement the anonymizer 108.

As describe above, the hash processor 302 receives a static owner identifier and in combination with a machine generated cryptographic salt generates a hash output 310 (HASH1). The anonymizer 108 associates the hash output (HASH1) 310 with an anonymous identifier 312 (AID1). The hash output 310 and the associated anonymous identifier 312 may be stored, for example in a look-up table or other similar structure such as repository 314. The hash output 310 and the anonymous identifier 312 may be stored in non-volatile storage of the memory unit.

The anonymous identifier 312 is associated in a one-to-one relationship with the hash output 310. The anonymous identifier may be produced by an anonymous identifier generator 318. The anonymous identifier 312 may be a unique random number or string or a unique number provided in a sequential order. Each anonymous identifier is associated with a unique hash output. Before generating a new anonymous identifier, the anonymizer 108 may check the hash outputs 310 stored in the repository 314 to determine if the hash output is already associated with an anonymous identifier 312. If the hash output 310 is already stored in the repository 314 and associated with an anonymous identifier 312, a new anonymous identifier does not need to be created. If however, the hash output 312 is not already stored in the repository 314, and so is not associated with an anonymous identifier 314, then a new anonymous identifier 312 is generated and the hash output 310 and new anonymous identifier 312 is then stored in the repository. The anonymous identifier 312 may be provided to third party processors 122.

Once the anonymous identifier 312 associated with the hash output 310 is determined, either by creating a new anonymous identifier or retrieving it from the repository 310, it is associated with at least a portion of the data 104 (DATA1) 316 that was associated with the static owner identifier 106. DATA1 316 may be a portion of the data associated with the static owner identifier, or may be based on the data associated with the static owner identifier. Regardless of what DATA1 316 is, it is associated with the anonymous identifier 312 that in turn is associated with the hash output 310 of the static owner identifier 106. The anonymous identifier 312 and DATA1 316 may be stored in an anonymized repository 114. The anonymized repository 114 is depicted as being part of the anonymizer 108; however, rather than storing the anonymized data, the anonymizer may provide the anonymous identifier of a static owner identifier to another component or process external to the anonymizer 108 to be associated and stored with DATA1.

A third party processor 122 may access the anonymized repository 114 in order to process the anonymized data. All the data 316 that was originally associated with a particular static owner identifier 106 is associated with the same anonymous identifier so that all relationships between the data still exist; however, the anonymized data cannot be directly related back to a particular static owner identifier 106 or data owner.

Furthermore, the anonymizer may be configured to allow access to the data associated with an anonymous identifier. For example, a third party processor 122 may receive an identifier associated with a data owner and desire to retrieve data associated with the data owner from the anonymized repository 114. The third party processor 122 provides the identifier for which the anonymized data is requested. The identifier may then be used to determine the static owner identifier. The anonymizer may then determine the hash output using the static owner identifier and associated anonymous identifier stored in the repository 314. The anonymizer 108 may then be used to retrieve and provide the data associated with the anonymous identifier to the third party processor. By providing access to third parties, it is possible to allow the third parties to request data associated with a dynamic identifier, such as an IP address, and have the ISP provide the data from the anonymized data.

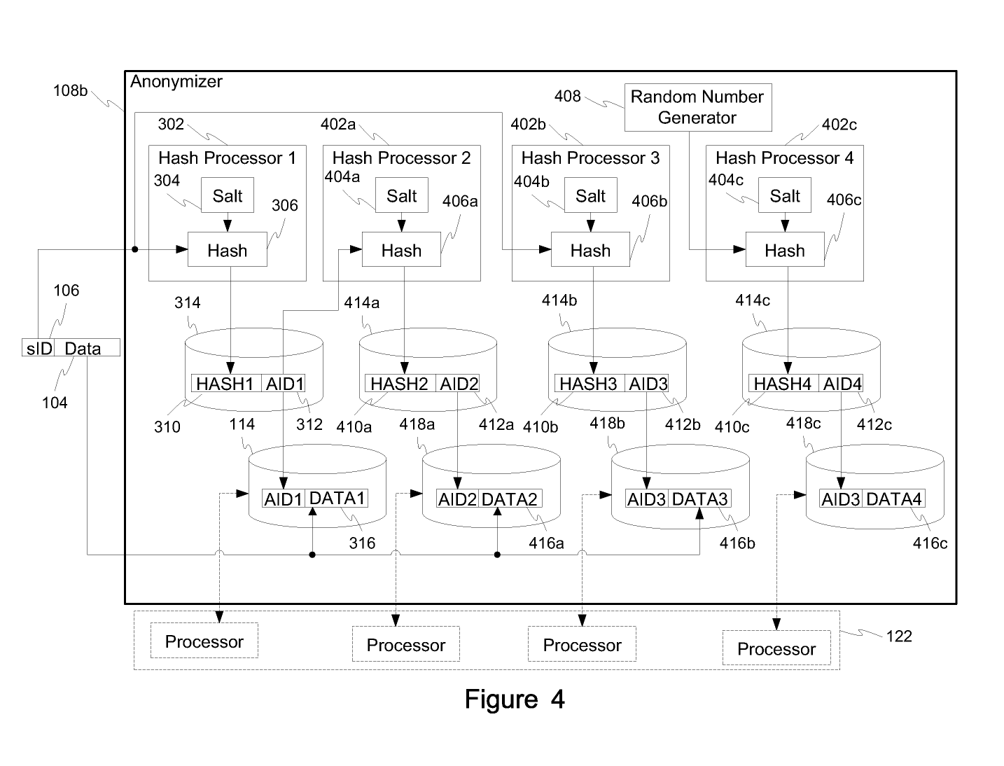

FIG. 4 depicts in a block diagram a further embodiment of an anonymizer 108b that may be used to anonymize data. The anonymizer 108b is similar to the anonymizer 108 described above with reference to FIG. 3. As such, many of the components of the anonymizer 108b which function substantially similar to the corresponding components of anonymizer 108 of FIG. 3 will not be described in further detail.

The anonymizer 108b is similar to that of FIG. 3; however it includes a plurality of additional hash processors 402a, 402b and 402c. It can be used advantageously to provide separate anonymous identifiers to different data, or to the same data that is provided to different processors 122. Each of the hash processors 402a, 402b, 402c operate in substantially the same way as hash processor 302; however the input to each of the hash process 406a, 406b, 406c may be different. Each hash process associates the respective hash output 410a, 410b, 410c with an anonymous identifier 412a, 412b, 412c which is stored in respective repositories 414a, 414b, 414c. Each anonymous identifier 412a, 412b, 412c may be associated with data 416a, 416b, 416c in anonymized repositories 418a, 418b, 418c.

The data 416a, 416b, 416c may be a portion of the data 104 associated with the static owner identifier 106. Additionally or alternatively some of the data 416a, 416b, 416c may be the same data as other data 416a, 416b, 416c. The data 416a, 416b, 416c may be different types of data received separately at the anonymizer 108b, or it may be different parts of data received at the anonymizer at the same time. The data 416a, 416b, 416c may also be derived from the received data 104. By providing multiple hash processors 402a, 402b, 402c it is possible to create separate anonymous identifiers for different pieces of data. As such, even if multiple pieces of data are provided to the same third party processor 122, the third party processor will not be able to associate data of one type from a particular data owner with data of another type from the same data owner since each type of data will be associated with a different anonymous identifier 312, 412a, 412b, 412c.

As described above, each hash processor 402a, 402b, 402c may use a different input instead of the static owner identifier 106 used by hash processor 306. IAn anonymizer 108, 108b may use different combinations of the inputs described herein. As depicted in FIG. 4, the input of the second hash processor 402a is the anonymous identifier that is associated with the hash output of the first hash processor 302. The output (HASH2) of the second hash processor 402a is then associated with an anonymous identifier 412b and stored in a repository 410a. As described above with regards to FIG. 3, the repository 414a is checked to determine if the hash output 410a is already stored in the repository 414a and so already associated with an anonymous identifier 412b.

It will be appreciated that the same repository may be used to store the hash output from multiple hash processors and associated anonymous identifiers. However, if the same repository is used, an indication of the hash processor used to generate the hash output should also be stored in order to ensure that if two hash processors generate the same hash output, they will be associated with different anonymous identifiers. Additionally or alternatively, the hash processors may be configured such that given the same input they produce different hash outputs. This may be done for example by having each hash processor use different cryptographic salts, different hash processes, or both different salts and different hash processes.

Since the input to the second hash processor 402a will always be different than the input to the first hash processor 302, both the hash process 406a and the salt 404a used by the second hash processor 402a may be the same as used by the first hash processor 302. However, additional security may be provided by using different cryptographic salts for each of the hash processors.

As depicted in FIG. 4, the third hash processor 402b uses the static owner identifier 106 as input. As described above, if the same repository is used to store the hash outputs from the first and third hash processors 302, 402b, the hash processors should be configured to ensure that given the same static owner identifier as input they produce different hash outputs so that different anonymous identifiers can be associated with the different hash outputs. The different hash outputs may be generated using, for example, using different cryptographic salts.

The hash processors 302, 402a, 402b each produce a given respective output for each static owner identifier. In contrast the hash processor 402c uses as input a random number produced by a random number generator 408. Since the hash processor 402c uses a random number as an input, multiple pieces of data associated with the same static owner identifier will likely result in different hash outputs and so be associated with different anonymous identifiers.

Each of the anonymous identifiers 312, 412a, 412b, 412c are associated with respective pieces of data 316, 416a, 416b, 416c and stored in one or more anonymous repositories 114, 418a, 418b, 418c. Any one of the third party processors 122 may then access the anonymous data repositories in order to process the data.

The third party processors may provide different functionality. For example, a third party processor may process the data for an ISP, for example generating a user profile from click stream data. Additionally or alternatively, a third party processor may request the retrieval of data associated with an identifier. The third party processor may provide the identifier to the ISP and receive data in response. For example, the anonymized data may include a user profile associated with a subscriber of the ISP. The profile data is associated with an AID. A third party processor may be, for example, an advertisement delivery service that provides advertisements for display on web sites or with other media. The third party processor receives an IP address of a subscriber to provide an advertisement for. The third party processor provides the IP address to the ISP, which determines the AID, as described above, and then retrieves the profile associated with the AID and provides the profile to the third party processor. The third party processor may then use the retrieved data, for example to provide an advertisement based on the retrieved profile.

FIG. 5 depicts in a block diagram a further embodiment of an anonymizer 108c that may be used to anonymize data. The anonymizer 108, 108b described above have been depicted as using a static owner identifier that is associated with a data owner. However, numerous networks use dynamic identifiers that are associated with the data owner. For example, an ISP network may dynamically assign an IP address to each data owner. The ISP network may keep track of the assignments of the IP addresses. As such, given a dynamic identifier, it is possible to determine the static owner identifier of the data owner that is currently associated with the dynamic identifier. FIG. 5 depicts an anonymizer 108c that can anonymize data associated with a dynamic identifier 506 instead of a static owner identifier as described above.

The anonymizer 108c is similar to the anonymizer 108 described above with reference to FIG. 3. As such, many of the components of the anonymizer 108c which function substantially similar to the corresponding components of anonymizer 108 of FIG. 3 will not be described in further detail.

As depicted in FIG. 5, the anonymizer 108c comprises, in addition to the components of anonymizer 108, a dynamic identifier translator 509, a dynamic to static owner identifier translation table 507, and a dynamic identifier monitor 505. The dynamic identifier monitor 505 monitors network traffic related to assigning the dynamic identifiers. The network traffic may comprise for example DHCP messages or RADIUS messages. The dynamic identifier monitor 505 determines new dynamic identifier assignments and updates the dynamic to static owner identifier translation table 507 to reflect the new dynamic identifier assigned to the static owner identifier.

The dynamic identifier translator 509 receives a dynamic identifier 506 associated with data 104 and uses the dynamic to static owner identifier translation table to determine the static owner identifier that is associated with the dynamic identifier. The dynamic translator 509 then provides the static owner identifier to the hash processor 302, which hashes the static owner identifier, associates the hash output 310 of the hash process 306 with an anonymous identifier 312 and associates the anonymous identifier 312 with data 316 as described above with regards to FIG. 3.

Although FIG. 5 depicts the anonymizer 108c as comprising the components for translating the dynamic identifier to the static owner identifier. It will be appreciated that the components may be provided externally to the anonymizer Additionally, the dynamic identifier may be translated in different ways. For example, an ISP may provide functionality for determining a static owner identifier from a dynamic identifier. An anonymizer may then use the ISPs functionality to request the static owner identifier currently associated with the dynamic identifier received by the anonymizer.

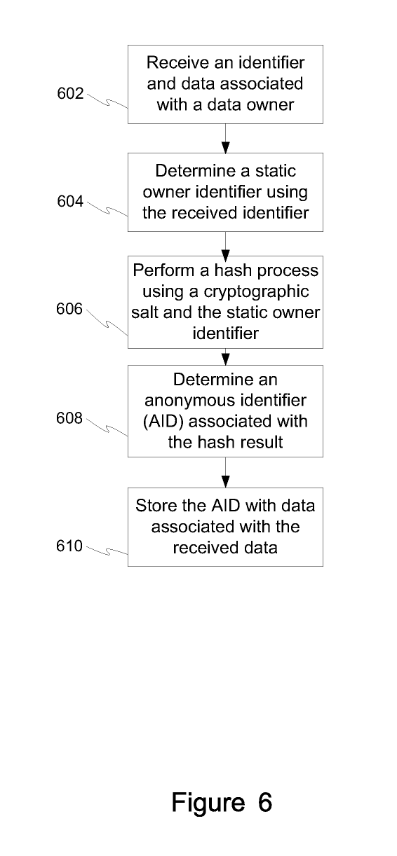

FIG. 6 depicts in a flow chart of a method of anonymizing data. The method depicted in FIG. 6 may be implemented in the hardware configured according to the description of FIGS. 1 to 5. The method receives an identifier and data associated with a data owner 602. The identifier may be a static identifier associated with the data owner or a dynamic identifier associated with the data owner for a period of time. A static owner identifier is determined using the received identifier 604. The static owner identifier may be determined in various ways. For example, if the received identifier is determined to be a static identifier it can be used as the static owner identifier. Alternatively, if the received identifier is determined to be a dynamic identifier, it can be used to look up an associated static owner identifier. Further still, if the identifier is a static identifier, it can be treated similar to a dynamic identifier and used to look up or retrieve an associated static owner identifier. A hash process is performed using the static owner identifier and a cryptographic salt 606 to produce a hash output. The output of the hash process is used to determine an associated anonymous identifier 608. The anonymous identifier may be determined, for example by determining if the output of the hash process is already stored and with an associated anonymous identifier. If the output of the hash process is already stored, the associated anonymous identifier can be retrieved. If the output of the hash process is not already stored, an anonymous identifier can be generated and the output of the hash process and the generated anonymous identifier stored together. The anonymous identifier associated with the hash output is stored with data associated with the received data 610. The stored data may be the data associated with the received identifier, it may be a portion of the data associated with the received identifier, it may be data resulting from processing the data associated with the received identifier or a combination there of.

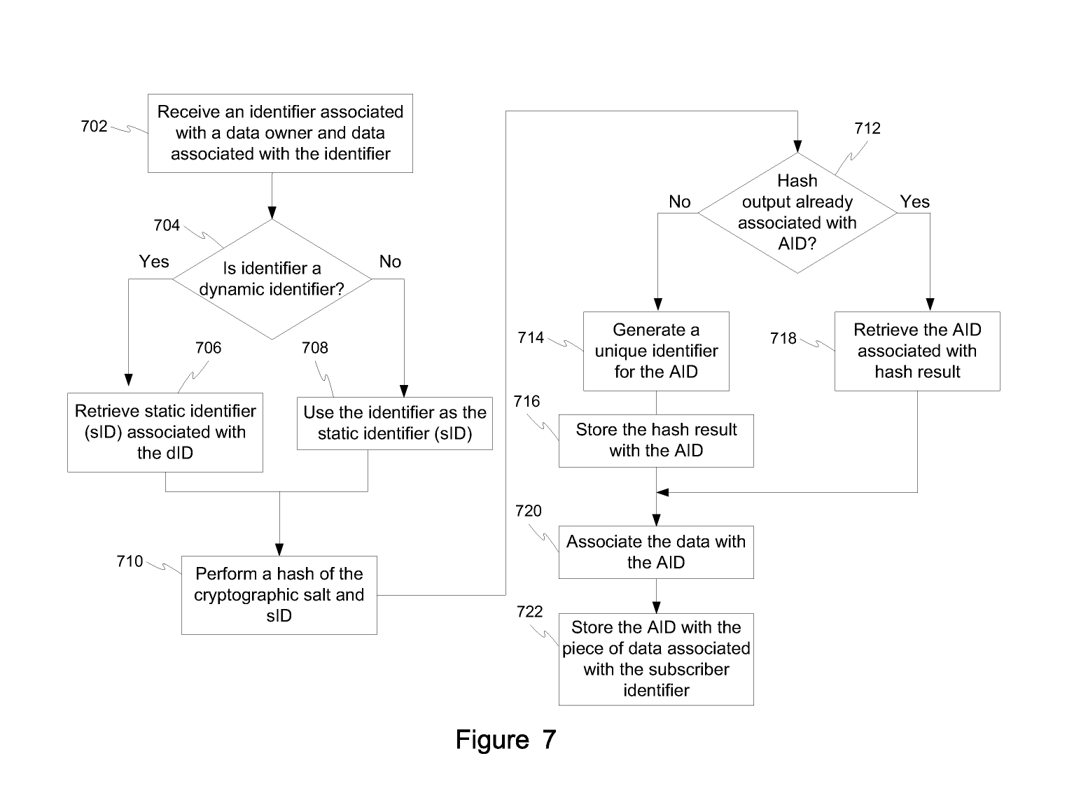

FIG. 7 depicts in a flow chart a further embodiment of a method of anonymizing data. The method depicted in FIG. 7 may be implemented in the hardware configured according to the description of the embodiments of FIGS. 1 to 5. The method receives an identifier associated with a data owner and data associated with the identifier 702. The method determines if the received identifier is a dynamic identifier 704. Whether the identifier is a dynamic identifier or not may be determined in various ways. For example, if the identifier is an IP address it may be determined to be a dynamic identifier. Although an IP address may be uniquely assigned to a single data owner and so may be considered a static identifier, the method can be configured to treat all IP addresses as a dynamic identifier since it may not be easily determined if an IP address is dynamically or statically assigned, and so convert them to static owner identifiers.

If the received identifier is determined to be a dynamic identifier (Yes at 704), a static owner identifier associated with the dynamic identifier is retrieved 706, for example using a dynamic to static owner identifier translation table. If the identifier is determined not to be a dynamic identifier (No at 704), the received identifier is used as the static owner identifier 708. Once the static owner identifier is determined either at (706 or 708), a hash is performed using the static owner identifier and a generated cryptographic hash 710. Once the hash output is generated it is determined if there is an anonymous identifier already associated with the hash output 712. If there is no anonymous identifier associated with the hash output (No at 712), a unique identifier is generated for the anonymous identifier 714 and the hash output and generated anonymous identifier are stored together 716. If the hash output is already associated with an anonymous identifier (Yes at 712) the anonymous identifier associated with the hash output is retrieved 718. The anonymous identifier is associated with a piece of data associated with the received identifier 720. The piece of data and anonymous identifier may be stored in a repository 722 and access to the data provided to one or more third party processors.

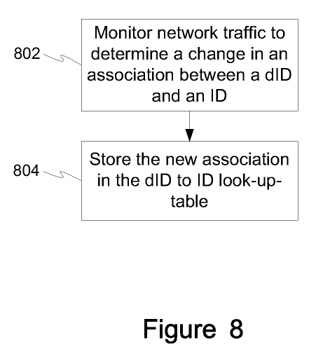

FIG. 8 depicts in a flow chart an embodiment of a method of tracking dynamic identifiers. The method monitors network traffic to determine a change in an association between a dynamic identifier and a static owner identifier 802. The traffic monitored may include DHCP traffic or RADIUS traffic. Once a new dynamic identifier assignment is determined from the monitored network traffic, the new association between the dynamic identifier and the static owner identifier is stored in a dynamic to static owner identifier translation table 804.

The method of FIG. 8 may be used to maintain a dynamic to static owner identifier translation table that in turn may be used by an anonymizer to translate received dynamic identifiers into static owner identifiers.

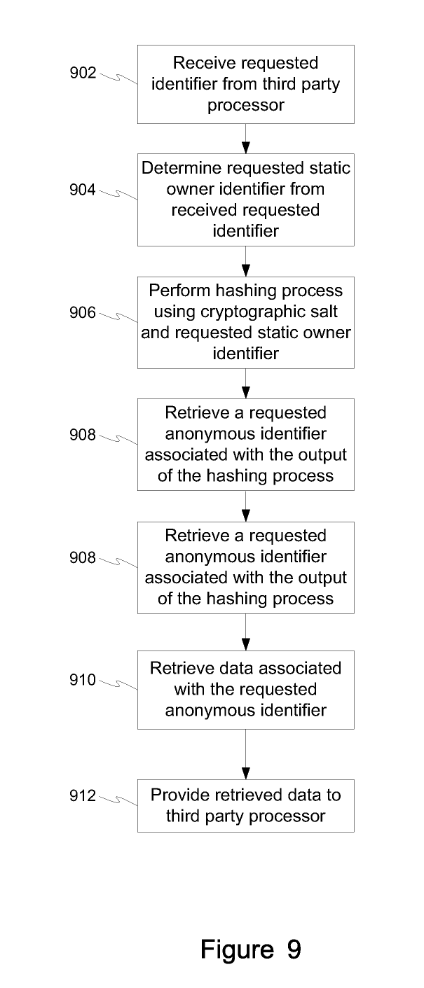

FIG. 9 depicts in a flow chart an embodiment of a method of providing access to anonymized data. The process is similar to the process of anonymizing data; however, instead of determining an AID to store with data, the method determines an AID and retrieves the data associated with the AID. A requested identifier is received from a third party processor 902. The received identifier may be a static identifier such as a MAC address or user name, or a dynamic identifier such as an IP address. For example, the third party processor could be an ad serving web site attempting to determine information associated with a particular IP address in order to provide a targeted advertisement. The identifier may be received by a provider of anonymized data, such as an ISP. A requested static owner identifier is determined from the received requested identifier 904. The static owner identifier may be determined in a similar manner as described above. A hashing process, using a generated cryptographic salt and the requested static owner identifier, is performed. The hashing process generates a requested one-way hash result associated with the requested static owner identifier 906. The requested static owner identifier is used to retrieved a requested anonymous identifier associated with the requested hash result 908. The requested anonymous identifier is used to retrieve data associated with the requested anonymous identifier that is stored in an anonymous data source 910. The retrieved data may then be provided to the third party processor 912 while maintaining the anonymity of the stored data.

The above description has described various systems and methods for anonymizing data. The systems and methods have been described with reference to various embodiments, and in particular to the implementation of the system and methods in an ISP network. The systems and methods described above can readily be adapted to anonymize data in environments or applications other than those described herein.

What is claimed is:

1. A method, implemented in a processing unit of anonymizing data of one or more data owners, the method comprising:
receiving an identifier and data associated with a data owner of the one or more data owners;
determining a static owner identifier using the received identifier;
performing a first hashing process using a first generated cryptographic salt and the static owner identifier to generate a first unique one-way hash result (HASH1) associated with the static owner identifier;
determining a first anonymous identifier (AID1) associated with the HASH1; and
storing in a memory unit associated with the processing unit the determined AID1 with at least a first portion of data (DATA1) associated.

2. The method of claim 1, wherein determining the AID1 comprises:
determining if the HASH1 is stored and associated with the AID1 in the memory unit;
retrieving the AID1 associated with the HASH1 in the memory unit when the HASH1 is stored in the memory unit; and
storing in the memory unit the HASH1 and the associated AID1 when the HASH1 is not stored in the memory unit.

3. The method of claim 1, further comprising:
receiving a requested identifier from a third party processor;
determining a requested static owner identifier from the received requested identifier;
performing the first hashing process using the first generated cryptographic salt and the requested static owner identifier to generate a requested one-way hash result associated with the requested static owner identifier;
retrieving from the memory unit associated with the processing unit a requested anonymous identifier associated with the requested hash result;
retrieving data associated with the requested anonymous identifier; and
providing the retrieved data to the third party processor in response to the received identifier.

4. The method of claim 1, further comprising:
performing a second hashing process using a second generated cryptographic salt and the AID1 to generate a second unique hash result (HASH2);
storing in the memory unit the HASH2 of the second hashing function with a second associated anonymous identifier (AID2); and
storing the AID2 with at least a second portion of data (DATA2) associated with the received data.

5. The method of claim 1, further comprising:
performing a second hashing process using a second generated cryptographic salt and the static owner identifier to generate a second unique hash result (HASH2);
storing in the memory unit the HASH2 of the second hashing function with a second associated anonymous identifier (AID2); and
storing the AID2 with at least a second portion of data (DATA2) associated with the received data.

6. The method of claim 1, further comprising:
performing a second hashing process on at least a second generated cryptographic salt to generate a second unique one-way hash result (HASH2);
storing in the memory unit the HASH2 of the second hashing function with a second associated anonymous identifier (AID2); and
storing the AID2 with at least a second portion of data (DATA2) associated with the received data.

7. The method of claim 1, wherein determining the static owner identifier comprises:
determining that the received identifier is a dynamic identifier; and
retrieving the static owner identifier associated with the dynamic identifier.

8. The method of claim 7, further comprising:
monitoring network traffic;
identifying messages associated with the assigned dynamic identifier to the data owner; and
storing the assigned dynamic identifier with the associated static owner identifier in a look-up table.

9. The method of claim 1, wherein determining the static owner identifier comprises:
determining that the received identifier comprises a static identifier; and
using the static identifier as the static owner identifier.

10. The method of claim 1, wherein determining the static owner identifier comprises:
determining that the received identifier comprises a static identifier; and
retrieving the static owner identifier associated with the static identifier.

11. The method of claim 1, wherein the first generated cryptographic salt is generated by an internal process and stored in memory associated with the first hashing process to be inaccessible to processes external to the first hashing process.

12. The method of claim 9, wherein the first generated cryptographic salt is stored in a non-volatile memory.

13. The method of claim 1, further comprising:
storing the DATA1 and AID1 in a first data store; and
providing access to the first data store to one or more data processors.

14. The method of claim 4, further comprising:
identifying a type of at least a portion of the received data; and
associating an associated identifier with the at least a portion of the received data using one of the first or second hashing processes based on the identified type of the at least the portion of the received data.

15. The method of claim 1, wherein the AID1 is one or more of:
a unique random number;
a random string; and
a unique number provided in a sequential order.

16. The method of claim 1, further comprising:
cascading a plurality of hashing processes together to anonymize portions of the received data, each hashing process using a unique generated cryptographic salt and the static owner identifier or a hash result from a previous hashing process.

17. The method of claim 1, further comprising:
determining if the HASH1 is already stored in the memory unit;
retrieving from the memory unit the AID1 associated with the HASH1 when the HASH1 is already stored in the memory unit; and
using the retrieved AID1 for associating with the DATA1.

18. The method of claim 1, wherein the DATA1 comprises one of:
at least a portion of processing results of the received data;
the received data; and
a portion of the received data.

19. A system for anonymizing data associated with a subscriber, the device comprising:
a computer readable memory unit for storing instructions and data;
a network interface coupling the device to a network; and
a processing unit for executing the instructions stored in the computer readable memory unit, the instructions when executed by the processing unit configuring the system to perform a method of anonymizing collected data associated with one or more data owners, the method comprising:
receiving an identifier associated with a data owner of the one or more data owners and associated data;
determining a static owner identifier from the received identifier;
performing a first hashing process using a first generated cryptographic salt and the static owner identifier to generate a first unique one-way hash result (HASH1) associated with the static owner identifier;
determining a first anonymous identifier (AID1) associated with the HASH1; and
storing in a memory unit associated with the processing unit the determined AID1 with at least a first portion of data (DATA1) associated with the received data.

20. A computer readable memory storing instructions for configuring a computer to perform a method of anonymizing collected data associated with one or more data owners, the method comprising:
receiving an identifier associated with a data owner of the one or more data owners and associated data;
determining a static owner identifier from the received identifier;
performing a first hashing process using a first generated cryptographic salt and the static owner identifier to generate a first unique one-way hash result (HASH1) associated with the static owner identifier;
determining a first anonymous identifier (AID1) associated with the HASH1; and
storing in a memory unit associated with the processing unit the determined AID1 with at least a first portion of data (DATA1) associated with the received data.
